(19) United States
(12) Patent Application Publication
(10) Pub. No.: US 2016/0233620 A1
(43) Pub. Date: Aug. 11, 2016

(54) CABLE CONNECTOR ASSEMBLY HAVING INTERNAL METALLIC SHIELD

(71) Applicant: FOXCONN INTERCONNECT TECHNOLOGY LIMITED, Grand Cayman (KY)

(72) Inventors: DA-WEI XING, Kunshan (CN); JUN CHEN, Kunshan (CN); JERRY WU, Irvine, CA (US)

(21) Appl. No.: 15/011,670

(22) Filed: Feb. 1, 2016

(30) Foreign Application Priority Data
Feb. 11, 2015 (CN) 201520095859.5

(51) Int. Cl. H01R 13/6594; H01R 24/28

(52) U.S. Cl. CPC H01R 13/6594; H01R 24/28

(57) ABSTRACT

A cable connector assembly includes: a printed circuit board (PCB) having a front end, a rear end, and an intermediate portion; a cable electrically connected to the rear end of the PCB; an inner metal member disposed about the intermediate portion of the PCB; an insulating member holding the inner metal member in position relative to the PCB; a metallic shield disposed around the insulating member; a front metal casing engaging the metallic shield; a rear metal casing surrounding a front of the cable and engaging the front metal casing; and an outer over-mold surrounding the front and rear metal casings.

### BACKGROUND OF THE INVENTION

1. Field of the Invention

The present invention relates generally to a cable connector assembly having an internal printed circuit board (PCB), an internal metallic shield, a front and rear metal casings, and an outer over-mold.

2. Description of Related Arts

U.S. Patent Application Publication No. 2015/0171562 discloses a connector receptacle and a mating connector insert (or connector plug, or cable connector). The connector receptacle includes a tongue carrying contacts or pads and a shield surrounding the tongue. The connector insert may include a shield located around an insulative housing and plural contacts. A leading edge of the shield may be folded back into an opening of the connector insert to form one or more contacts.

U.S. Patent Application Publication No. 2014/0206209 discloses a reversible Universal Serial Bus (USB) plug connector including a tongue, a support structure from which the tongue extends, and a base that may be attached over metallic shield and cable. A shell may be assembled with the base and extend longitudinally away therefrom. The support structure may be overloaded in position to support and provide increased deletion flexibility to the tongue. The tongue may be a PCB or may be made from one or more of a variety of dielectric materials.

A cable connector assembly having an internal metallic shield is desired.

### SUMMARY OF THE INVENTION

An object of the present invention is to provide a cable connector assembly that is easy to manufacture and reliable in structure.

To achieve the above-mentioned object, a cable connector assembly includes: a printed circuit board (PCB) having a front end, a rear end, and an intermediate portion; a cable electrically connected to the rear end of the PCB; an inner metal member disposed about the intermediate portion of the PCB; an insulating member holding the inner metal member in position relative to the PCB; a metallic shield disposed around the insulating member; a front metal casing engaging the metallic shield; a rear metal casing surrounding a front of the cable and engaging the front metal casing; and an outer over-mold surrounding the front and rear metal casings.

### BRIEF DESCRIPTION OF THE DRAWING

FIG. 1 is a perspective view of a cable connector assembly in accordance with the present invention;

FIG. 2 is a partially exploded view of the cable connector assembly in FIG. 1;

FIG. 3 is a further partially exploded view of the cable connector assembly in FIG. 2;

FIG. 4 is a view similar to FIG. 3 but from a different perspective;

FIG. 5 is a further partially exploded view of the cable connector assembly in FIG. 3;

FIG. 6 is a view similar to FIG. 5 but from a different perspective;

FIG. 7 is a further partially exploded view of the cable connector assembly in FIG. 5;

FIG. 8 is a view similar to FIG. 7 but from a different perspective; and

FIG. 9 is a cross-sectional view taken along line A-A in FIG. 1.

### DETAILED DESCRIPTION OF THE PREFERRED EMBODIMENT

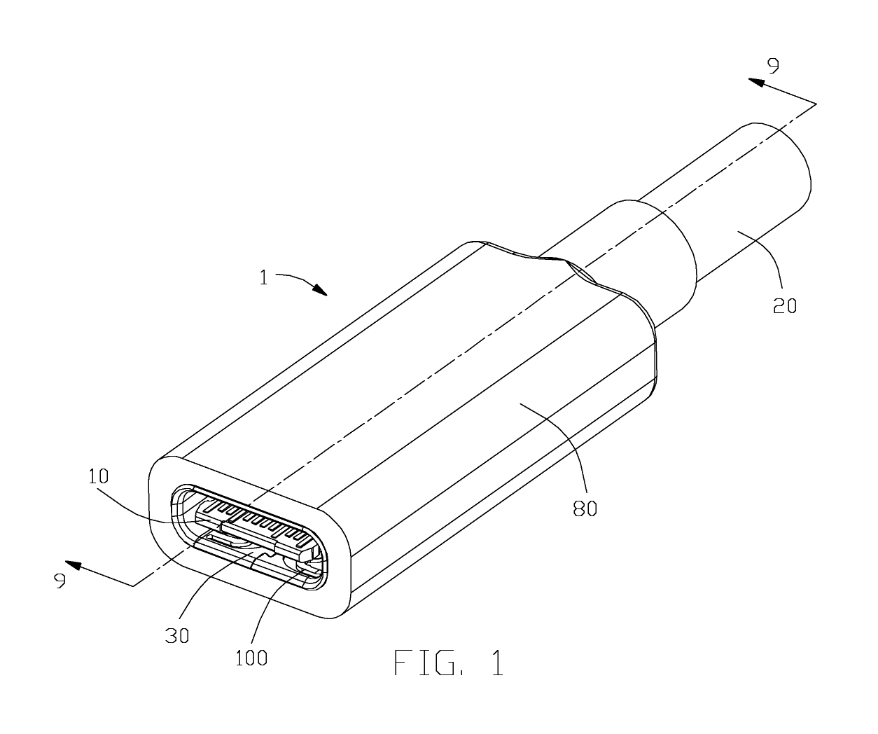

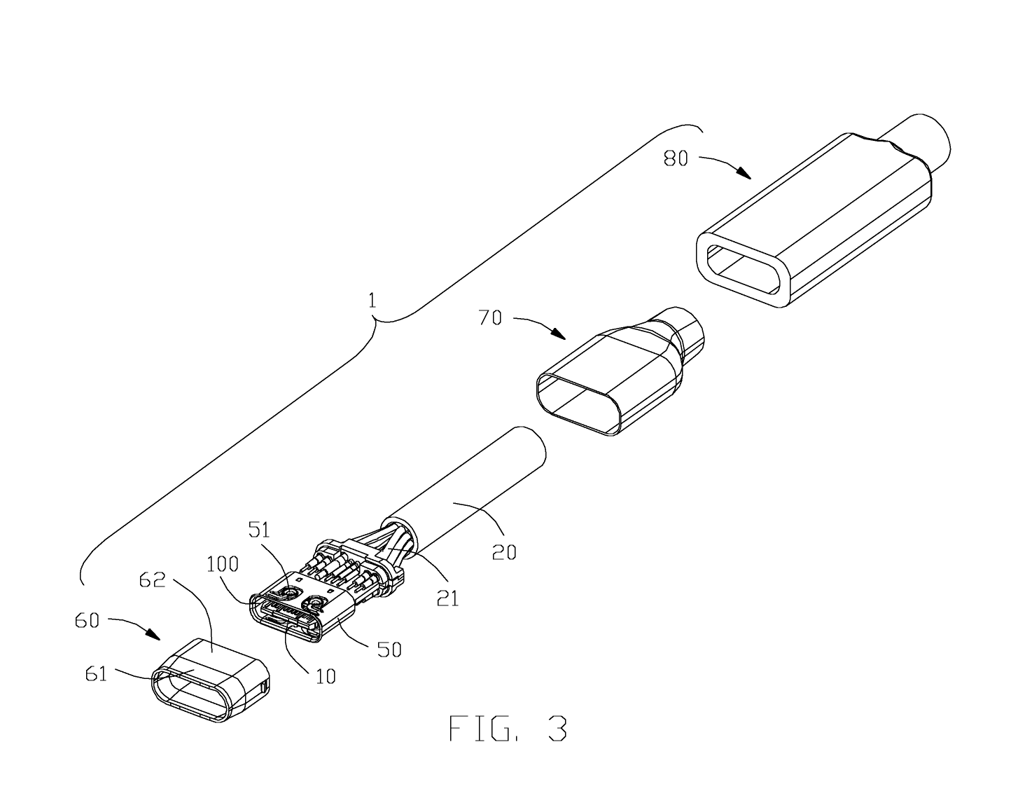

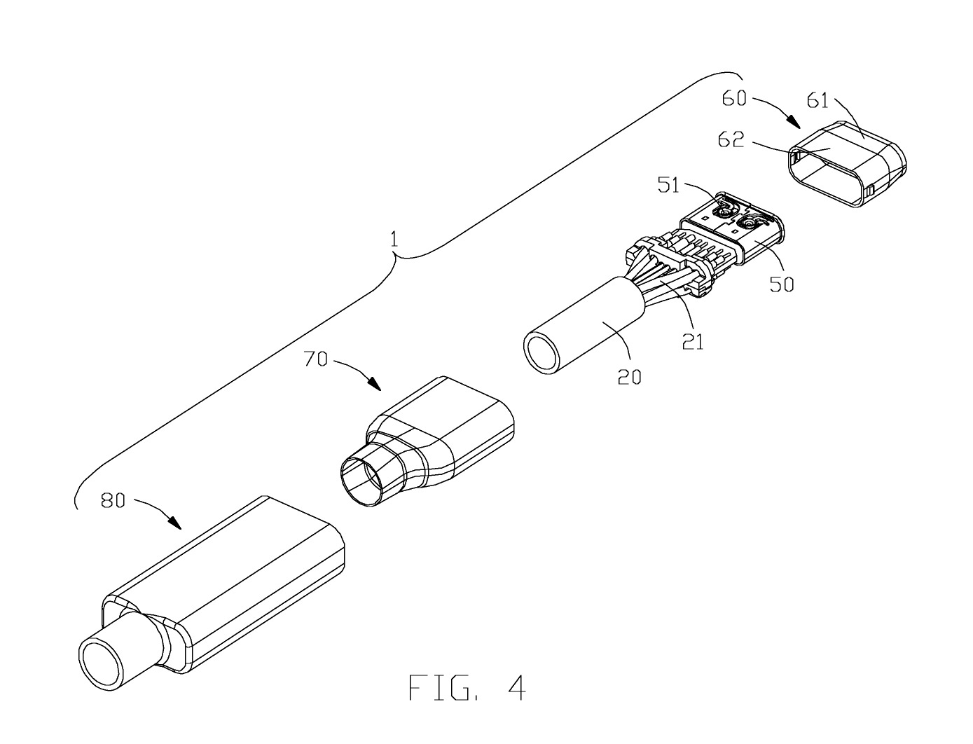

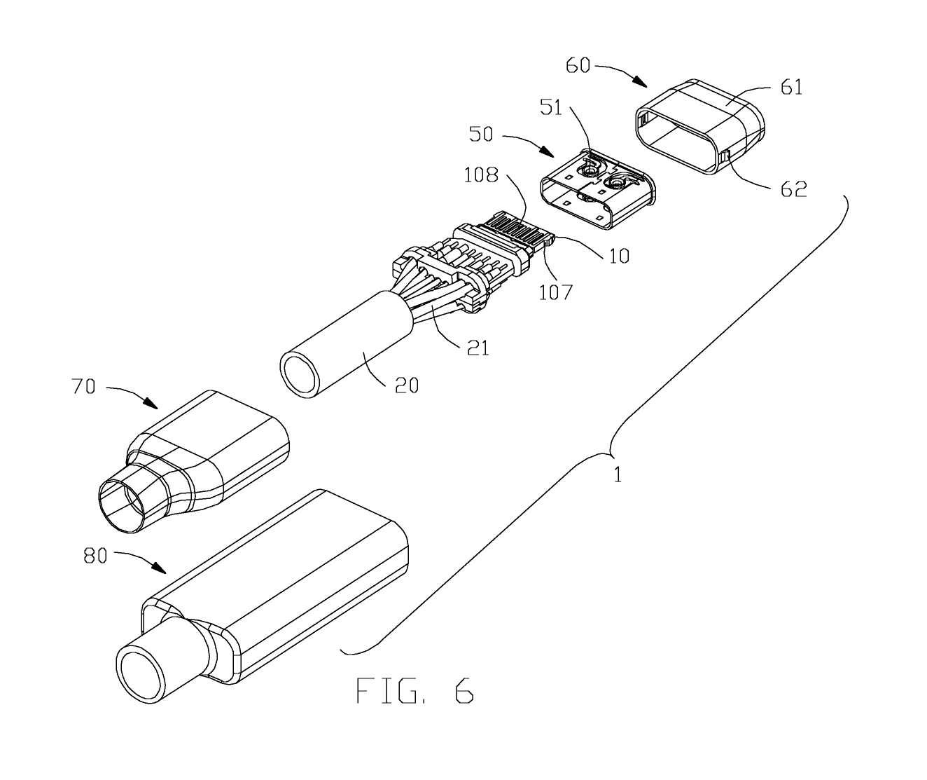

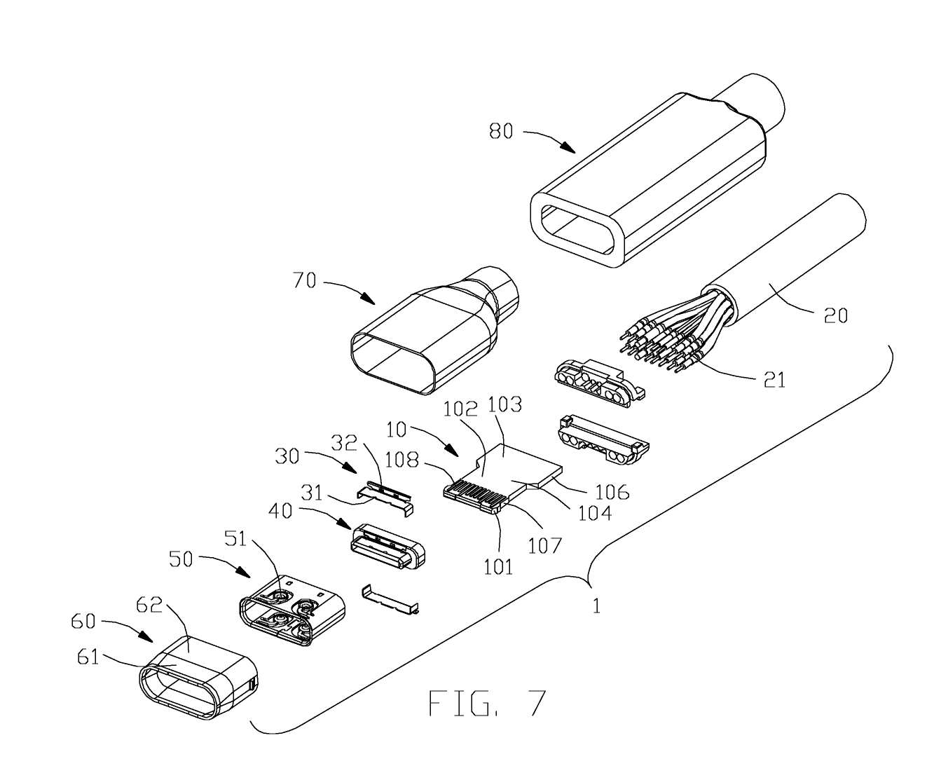

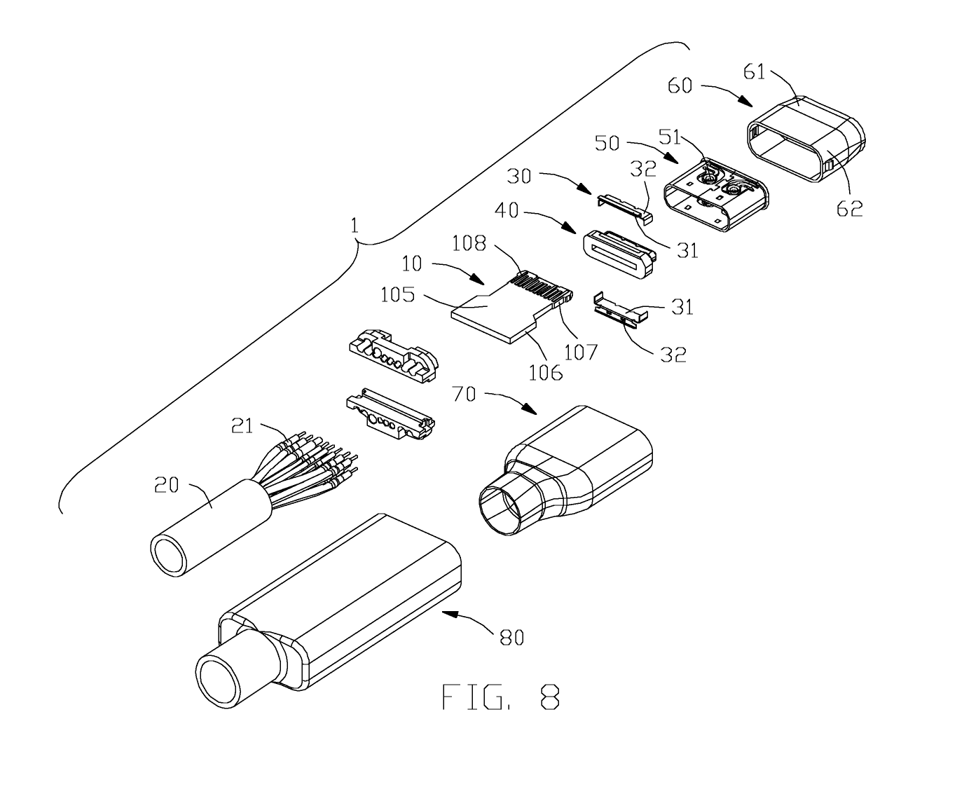

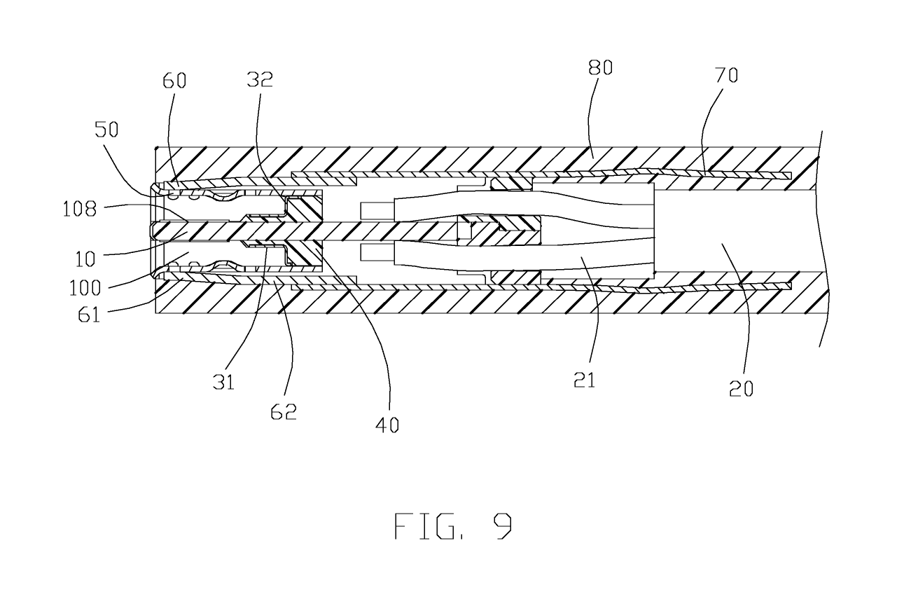

Referring to FIGS. 1 to 9, a cable connector assembly 1, which is adapted to be mated with the plug connector as shown in US Pub. No. 20150288107 disclosed in the Information Disclosure Statement, in accordance with the present invention comprises a PCB 10, a cable 20 electrically connected to the PCB 10, an inner metal member 30 disposed about the PCB 10, an insulating member 40 holding the inner metal member 30 in position relative to the PCB 10, a metallic shield 50 around the insulating member 40, a front metal casing 60 surrounding the metallic shield 50, a rear metal casing 70 surrounding a front of the cable 20 and secured to the front metal casing 60, and an outer over-mold 80 surrounding the front and rear metal casings 60 and 70. The cable connector assembly 1 is provided with a space 100 for insertion of a mating connector to connect with the PCB 10. Notably this connector is equipped with the so-called USB type C interface, so the cable connector assembly is reversible to be able to mate in two orientations.

The PCB 10 includes a front end 101, a rear end 103 for connecting to the cable 20, and an intermediate portion 102. The width of the front end 101 is larger than the width of the intermediate portion 102 but is less than the width of the rear end 103. The circuit board 10 includes an upper surface 104, a lower surface 105, and a pair of side surfaces 106. The side surface 106 is provided with a conductive/grounding pad 107 which is electrically connected to a grounding layer of the printed circuit board 10. Each of the upper and lower surfaces 104 and 105 has a plurality of conductive pads 108. In this embodiment, the lateral side edges of the PCB 10 is directly formed with the locking structure (not labeled) around the conductive pads 107 for engagement with the pair of metal side latches 133 of the aforementioned U.S. Pub. No. 20150288107 wherein such a metal side latch 133 is mechanically and electrically connected to the conductive pad 107 during mating.

The cable 20 includes a number of wires 21 arranged in two rows, via assistance of a wire organizer (not labeled) behind the PCB 10, on the upper and lower surfaces 104 and 105 of the PCB 10, respectively. The cable 20 establishes electrical connection with a mating connector through the PCB 10.

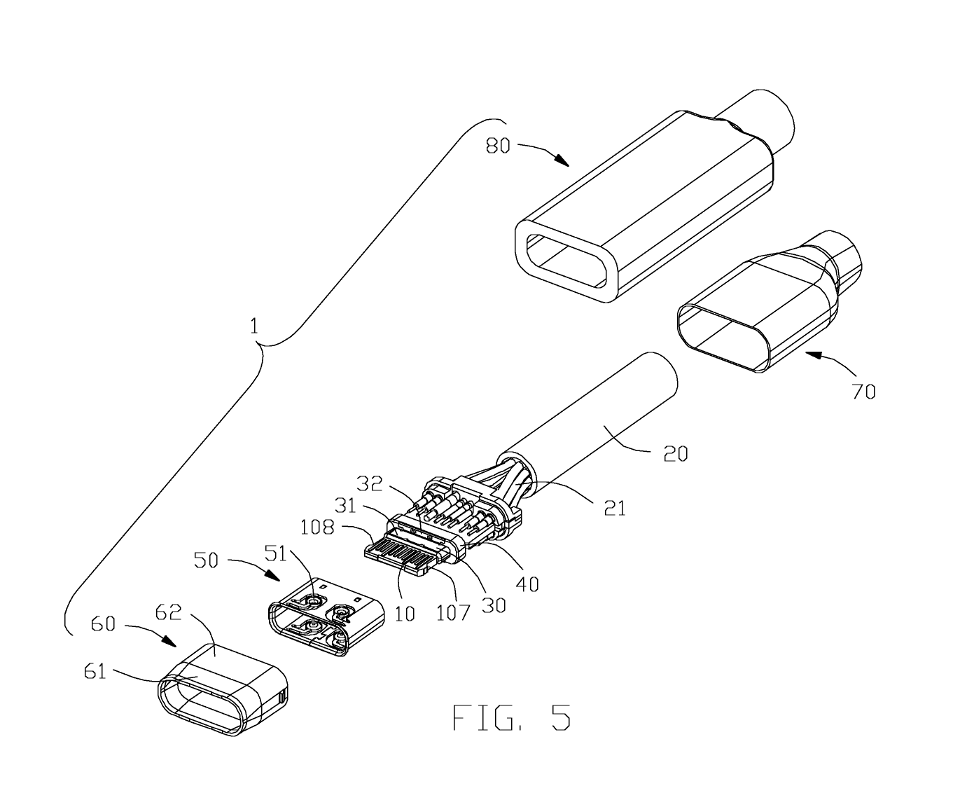

As shown in FIGS. 5-9, the inner metal member 30 to be grounded for EMI shielding purpose is constructed of two pieces each including a front portion 31 surrounding the PCB 10 and a rear portion 32. The inner metal member 30 may also be a one-piece construction. The inner metal member 30 is provided at the intermediate portion 102 of the PCB 10. Notably, during mating, the inner metal member 30 is mechanically and electrically connected to the grounding member 16 of the aforementioned U.S. Pub. No. 20150288107. The insulating member 40 is molded with the PCB 10 to hold the metal member 30 and the PCB 10 together.

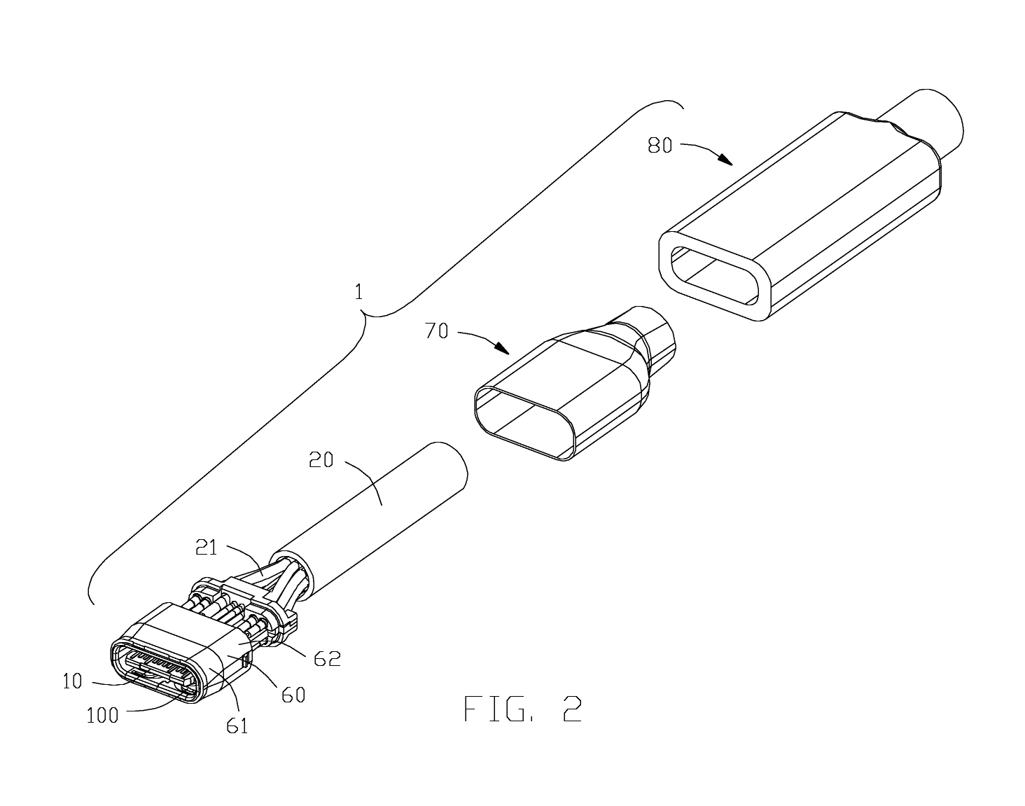

As shown in FIGS. 2-9, the metallic shield 50 is a through construction having a front, uninterrupted flared flange and enclosing the inner metal member 30. The shield 50 has a pair of upper spring arms 51 and a pair of lower spring arms 51 for engaging a mating connector to increase retention force. The spring arms 51 are generally symmetrically arranged.

The front metal casing 60 is preferably formed by metal drawing process to have an uninterrupted structure. The front metal casing 60 has a front portion 61 for engaging the metallic shield 50 and a rear portion 62 of a larger radial dimension than the front portion 61 for adapting to the spring arms 51 of the shield 50.

The rear metal casing 70 is also preferably formed by metal drawing process to have an uninterrupted structure. A front of the metal casing 70 engages a rear of the metal casing 60. A rear of the metal casing 70 encloses the cable 20. After the rear end of the metal sleeve housing 70 provided on the cable 20. The over-mold 80 is molded outside the front and rear metal casings 60 and 70.

Notably, in the instant invention the printed circuit board 10 functions as a mating tongue 54 of U.S. Pub. No. 20150229077 as shown in the Information Disclosure Statement, to be mated with a plug connector and inherently includes at the middle level, a grounding layer (not shown) functioning as the shielding plate 76 of the mating tongue 54 of the aforementioned U.S. Pub. No. 20150229077. Notably, the typical type C receptacle connector disclosed in the aforementioned U.S. Pub. No. 20150229077 is mounted to the mother board while the instant invention is to connect to the cable. On the other hand, instead of directly forming the locking structure on two opposite side edges of the printed circuit board 10, an insulative frame (not shown) alternately may be provided upon the front edge and two opposite side edges of the PCB 10 to protect the PCB 10.

What is claimed is:

1. A cable connector assembly comprising:
a printed circuit board (PCB) having a front end, a rear end, and an intermediate portion;
a cable electrically connected to the rear end of the PCB;
an inner metal member disposed about the intermediate portion of the PCB;
an insulating member holding the inner metal member in position relative to the PCB;
a metallic shield disposed around the insulating member;
a front metal casing engaging the metallic shield;
a rear metal casing surrounding a front of the cable and engaging the front metal casing; and
an outer over-mold surrounding the front and rear metal casings.

2. The assembly as claimed in claim 1, wherein the metallic shield has a plurality of spring arms for engaging a mating connector to increase retention force.

3. The assembly as claimed in claim 1, wherein the front metal casing has a front portion engaging the metallic shield and a rear portion adapted to the spring arms of the metallic shield.

4. The assembly as claimed in claim 1, wherein the insulating member is molded with the PCB and the metal member.

5. An electrical cable connector assembly comprising:
a printed circuit board defining opposite front region, rear region and an intermediate region therebetween along a front-to-back direction;
a plurality of conductive pads formed on the front region for mating with a plug connector;
a cable including a plurality of wires mechanically and electrically connected to the rear region;
an insulating member mounted upon the intermediate region;
an inner metal member positioned upon the insulating member for grounding; and
a metal casing enclosing the front region including the conductive pads and the intermediate region including the inner metal member and the insulating member.

6. The electrical cable connector assembly as claimed in claim 5, wherein two opposite lateral side edges around the front region are equipped with latching structures for locking with corresponding side latches of a plug connector adapted to be mated therewith.

7. The electrical cable connector assembly as claimed in claim 6, wherein said two opposite lateral side edges are equipped with grounding pads, respectively.

8. The electrical cable connector assembly as claimed in claim 7, wherein said grounding pads are electrically connected to a grounding layer embedded within a middle level of the printed circuit board.

9. The electrical cable connector assembly as claimed in claim 5, wherein said metal casing forms a plurality of spring arms extending into a mating cavity in which said front region extends.

10. The electrical cable connector assembly as claimed in claim 5, wherein said insulating member fully surrounds the intermediate region via an injection process.

11. The electrical cable connector assembly as claimed in claim 10, wherein said inner metal member is integrally formed and embedded within the insulating member while exposing contacting surface toward the metal casing.

12. The electrical cable connector assembly as claimed in claim 5, wherein a rear metallic shell encloses the rear region and the wires, and an overmold covers the rear metallic shell.

13. The electrical cable connector assembly as claimed in claim 12, further including a wire organizer through which the wires extend for wire regulating.

14. The electrical cable connector assembly as claimed in claim 13, wherein the rear shell is supported by the wire organizer.

15. The electrical cable connector assembly as claimed in claim 5, further including a front metallic shell enclosing the metal casing.

16. The electrical cable connector assembly as claimed in claim 5, wherein said inner metal member is mechanically and electrically connected to the metal casing.

17. An electrical cable connector assembly comprising:
a printed circuit board defining opposite front region, rear region and an intermediate region therebetween along a front-to-back direction;
a plurality of conductive pads formed on the front region for mating with a plug connector;
a cable including a plurality of wires mechanically and electrically connected to the rear region; and
a metal casing enclosing the front region including the conductive pads; wherein
each of two opposite lateral side edges is equipped with a latching structure having a grounding means thereon for electrically and mechanically connecting with a side latch of a plug connector adapted to be mated within the metal casing.

18. The electrical cable connector assembly as claimed in claim 17, wherein the metal casing forms a plurality of spring arms extending into a mating cavity in which the front region extends.

19. The electrical cable connector assembly as claimed in claim 17, wherein said latching structure is directly formed unitarily on the printed circuit board.

20. The electrical cable connector assembly as claimed in claim 17, further including an inner metal member located around the intermediate region in the metal casing and mechanically and electrically contacting the metal casing.
